(19) United States
(12) Patent Application Publication
(10) Pub. No.: US 2016/0098994 A1
(43) Pub. Date: Apr. 7, 2016

(54) CROSS-PLATFORM DIALOG SYSTEM

(71) Applicant: Speaktoit, Inc., Palo Alto, CA (US)

(72) Inventors: Ilya Gennadyevich Gelfenbeyn, Sunnyvale, CA (US); Artem Goncharuk, Arlington, VA (US); Pavel Aleksandrovich Sirotin, Sunnyvale, CA (US)

(73) Assignee: SPEAKTOIT, INC., Palo Alto, CA (US)

(21) Appl. No.: 14/873,905

(22) Filed: Oct. 2, 2015

Related U.S. Application Data
(60) Provisional application No. 62/059,188, filed on Oct. 3, 2014.

(51) Int. Cl. G10L 15/22; G10L 15/30; G10L 15/18

(52) U.S. Cl. CPC G10L 15/22; G10L 15/1822; G10L 15/30

(57) ABSTRACT

Provided are systems and methods for operating a dialog system in a cross-platform environment. The method comprises receiving, by a server comprising at least one processor and a memory storing processor-executable codes, a first request from a first client device to initiate operation of the dialog system. The first client device is identified based at least on the first request. Based on the identification, a first set of predetermined settings associated with a user and the first client device is applied to the dialog system. The operation of the dialog system according to the first set of predetermined settings is initiated and the dialog system is connected to the first client device.

### RELATED APPLICATIONS

The present application relies on and claims benefit of priority under 35 U.S.C. from U.S. Provisional Application Ser. No. 62/059,188, filed Oct. 3, 2014, which application is hereby incorporated by reference in its entirety.

### TECHNICAL FIELD

This disclosure relates generally to dialog systems and, more particularly, to a dialog system in a cross-platform environment enabling delivery of a device-neutral interface and application of user-specific settings of the dialog system regardless of the client device used.

### DISCLOSURE OF RELATED ART

Dialog systems are widely used in the information technology industry, especially as mobile applications for wireless telephones and tablet computers. Generally, a dialog system refers to a computer-based agent having a human-centric interface for accessing, processing, managing, and delivering information. The dialog systems are also known as chat information systems, spoken dialog systems, conversational agents, chatter robots, chatterbots, chatbots, chat agents, digital personal assistants, automated online assistants, and so forth. All these terms are within the scope of the present disclosure and referred to as a “dialog system” for simplicity.

Traditionally, a dialog system interacts with its users in natural language to simulate an intelligent conversation and provide personalized assistance to the users. For example, a user may generate requests to the dialog system in the form of conversational questions, such as “Where is the nearest hotel?” or “What is the weather like in Arlington?”, and receive corresponding answers from the dialog system in the form of an audio and/or displayable message. The users may also provide voice commands to the dialog system so as to perform certain functions including, for example, generating emails, making phone calls, searching particular information, acquiring data, navigating, providing notifications and reminders, and so forth. Thus, dialog systems are now very popular and are of great help especially for holders of portable electronic devices such as smart phones, cellular phones, tablet computers, gaming consoles, and the like.

In some instances, dialog systems enable users to create user-specific rules or settings. For example, a user can customize an avatar of a dialog system, a voice tone for audio messages to be delivered by the dialog system, the way dialog system messages are delivered to the user, and so forth. In addition, a user can create or customize specific dialog system rules, which allow performing certain functions in response to particular user commands. One of the core disadvantages of state-of-the-art dialog systems is that user-specific settings and rules are available on a single client device only. In many instances, if the dialog system is accessed by the user from another client device, many or all predetermined settings or rules may not be available to the user because settings and rules may be linked to hardware or software of a particular client device.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to approaches for operating a dialog system in a cross-platform environment. According to an aspect of the present disclosure, there is provided a method for operating a dialog system in a cross-platform environment. The method may commence with receiving, by a server comprising at least one processor and a memory storing processor-executable codes, a first request from a first client device to initiate operation of the dialog system. The method may continue with identifying the first client device based at least on the first request. The method may further include applying, by the server, a first set of predetermined settings to the dialog system based on the identification. The first set of predetermined settings is associated with a user and the first client device. The method may further include initiating, by the server, the operation of the dialog system and connecting the dialog system to the first client device.

According to another approach of the present disclosure, a system for operating a dialog system in a cross-platform environment is provided. The system may include a dialog system and a dialog system manager. The dialog system may be deployed on a server and configured to generate and communicate a response upon receipt of a request of a user. The dialog system manager may be deployed on the server and configured to receive a first request from a first client device to initiate operation of the dialog system. The dialog system manager may further be configured to identify the first client device based at least on the first request. Based on the identification, a first set of predetermined settings may be applied to the dialog system. The first set of predetermined settings may be associated with the user and the first client device. The dialog system manager may further initiate the operation of the dialog system and connect the dialog system to the first client device. Upon receiving a second request from a second client device, the dialog system manager may similarly identify the second client device and apply a second set of predetermined settings to the dialog system when initiated for the second client device.

In further example embodiments of the present disclosure, the method steps are stored on a machine-readable medium comprising instructions, which when implemented by one or more processors perform the recited steps. In yet further example embodiments, hardware systems or devices can be adapted to perform the recited steps. Other features, examples, and embodiments are described below.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram showing an environment within which methods and systems for operating a dialog system in a cross-platform environment may be implemented, in accordance with an example embodiment.

FIG. 2 is a process flow diagram showing a method for operating a dialog system, according to an example embodiment.

FIG. 3 is a high-level block diagram illustrating an example client device suitable for implementing the method for operating a dialog system in a cross-platform environment, in accordance with an example embodiment.

FIG. 4 a high-level block diagram illustrating the dialog system backend server suitable for implementing the method for operating a dialog system in a cross-platform environment, in accordance with an example embodiment.

FIG. 5 a high-level architecture of exemplary spoken dialog system, according to an example embodiment.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

The present technology overcomes at least some drawbacks of state-of-the-art dialog systems and provides for a cross-platform dialog system enabling a user to create user-specific settings and/or rules, which are operative regardless of a type of client device used. Moreover, the user-specific settings and/or rules can be dynamically configured or adapted for a particular client device based on hardware and/or software of this client device.

In one example embodiment, a user of a dialog system may customize an avatar by selecting or creating an image of the avatar. Moreover, the user may customize audio parameters of a voice (e.g., a tone, accent, pitch, etc.) of the dialog system for audio messages. Additionally, the user may select specific settings/rules of the dialog system, such as external services data, restaurant preferences, demographics data (e.g., age, and gender), category preferences (e.g., a favorite sports team and a music genre), contact data (e.g. family information, friend information, and friend preferences), location data (e.g., home location, work location, and frequent location), personal contact data (e.g., home phone number and work phone number), vehicle data (e.g., whether a vehicle is moving and whether music is playing). The user may also select environmental and/or contextual data, such as device specific location data (e.g., GPS location and other environmental data). Accordingly, regardless of the client device used, these user-specific settings may be applied to the dialog system. It means the user may see one and the same customized avatar and/or hear the same customized dialog system voice whenever he uses a mobile device, a tablet computer, laptop computer, and the like to access the dialog system.

In another example embodiment, the user of a dialog system may create events that are available to the user regardless of the particular client device used. For example, the user may create a record in a calendar with the help of a dialog system and request the dialog system to send a push notification or reminder at some time in the future. Accordingly, the dialog system may generate and send the notification or reminder either to all client devices of the particular user or to a selected client device being currently used by the user.

In yet another example embodiment, the user of a dialog system may create user-specific dialog rules, which can be triggered based on hardware and/or software availability. For example, the user may train the dialog system to navigate him to his home when he provides a specific voice command such as “Home.” In this regard, if the dialog system identifies that the user is currently using his smart phone, the dialog system distantly activates a navigation software application on his smart phone, such as Google Maps®, and instructs it to create a route to the user's home. Alternatively, if the dialog system identifies that the user is currently using his in-vehicle computing system to access the dialog system, the dialog system distantly activates a corresponding navigation software application available at the in-vehicle computing system and instructs it to create a route and navigate the user to his home. In yet another alternative, if the dialog system identifies that the user is currently using his laptop computer, the dialog system determines that the laptop computer has no specific navigational software and GPS receiver. Accordingly, in this case, the dialog system may distantly activate a browser on the laptop computer, and then open a specific webpage or access a specific web service such as a navigational service available in the Internet (e.g., a web navigational service available at http://www.google.com/maps) and instruct it to navigate the user to his home.

In light of the foregoing, the predetermined user-specific settings and rules of the dialog system can be divided into a first group of settings and rules that are user-specific but tolerant to a client device used (e.g., avatar settings; device settings, such as display settings, audio settings, Wi-Fi settings, GPS settings, and personalization settings; environmental data, such as current device settings, GPS data, local time data, and time zone data) and a second group of settings and rules that are user-specific and intolerant to a client device used. Notably, the second group of settings and rules can be further divided into multiple sets of settings and rules, each of which can be associated with a particular client device. For example, one set of settings and/or rules can be virtually linked to a smart phone of a particular user, while another set of settings and/or rules can be virtually linked to a laptop computer of the same user, and, at last, a third set of settings and/or rules can be virtually linked to a tablet computer of the same user.

Therefore, once the dialog system is activated or requested to be activated by the user, it first identifies which client device is currently used by the user and, based on this identification, a particular set of settings and/or rules are retrieved from a database and applied to the dialog system.

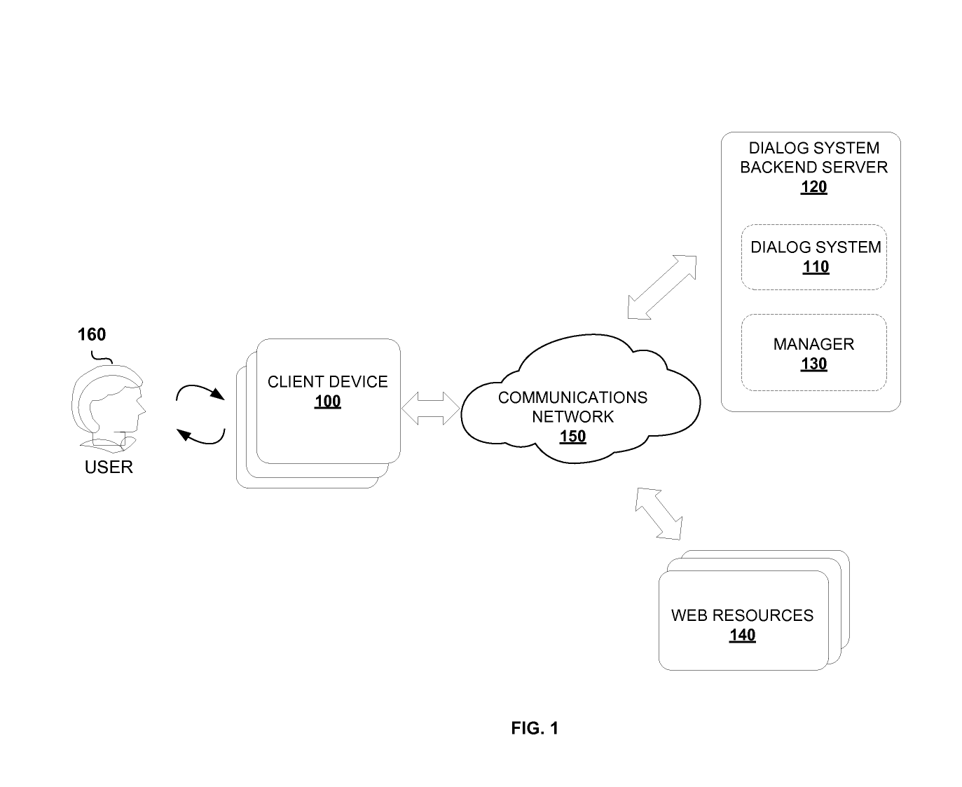

FIG. 1 shows a high-level block diagram of an example system environment suitable for practicing the present technologies. In some example embodiments, this environment refers to a distributed system environment or “cloud-based” system environment. In this example, there is provided a client device 100, which refers to a smart phone, wireless telephone, and computer, such as a tablet computer, desktop computer, laptop computer, infotainment system, in-vehicle computing device, and the like. The client device 100 may optionally include software enabling a connection to a dialog system 110, which runs on a dialog system backend server 120. Notably, any user may utilize a number of various client devices 100; however, FIG. 1 shows just one client device 100 for simplicity.

The dialog system 110 may relate to a distributed application meaning that some functions (such as recording of user inputs and delivering audio outputs) are implemented by the client device 100, while some other functions (such as voice recognition and generation a response) are performed on a server side. For example, the client device 100 can have installed a mobile application or widget configured to record user inputs, deliver them to the dialog system 110, receive a corresponding response from the dialog system 110, and present it to the user as a displayable and/or audio message. In other embodiments, the entire functionality of dialog system 110 can be implemented within the dialog system backend server 120 or within the client device 100.

As shown in the example of FIG. 1, the dialog system backend server 120 may also include a manager 130, which is configured to determine what type of client device 100 is currently used by the user. For example, the manager 130 determines the client device 100 when it receives a request from the client device 100 to initiate the operation of the dialog system 110. Once a type of the client device 100 is identified, the manager 130 retrieves user-specific settings and/or rules, which specifically relate to the type of client device 100 identified, and applies these settings and/or rules to the dialog system 110. In other embodiments, the settings and/or rules are received from client device 100 alongside the request.

Notably, the identification of the type of client device 100 can be based on analysis of an initial request received from the client device 100, which request may have a field identifying the client device 100. Alternatively, the dialog system manager 130 may request that the client device 100 provide information indicating its type or make.

Still referencing FIG. 1, there are also provided web resources 140, such as other email servers, websites, web services, and the like that can be accessed by the dialog system 110. The communication is performed via a communications network 150, which may include, for example, the Internet and cellular networks.

Suitable networks may include or interface with any one or more of, for instance, a local intranet, a personal area network, a local area network, a wide area network, a metropolitan area network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34b is analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, GPS, cellular digital packet data, Research in Motion, Limited duplex paging network, Bluetooth radio, or an IEEE 802.11-based radio frequency network. The network 110 can further include or interface with any one or more of an RS-232 serial connection, an IEEE-1394 (Firewire) connection, a fiber channel connection, an infrared port, a Small Computer Systems Interface connection, a Universal Serial Bus connection or other wired or wireless, digital or analog interface or connection, mesh or Digi® networking. The communications network 150 may include a network of data processing nodes that are interconnected for the purpose of data communication.

A user 160 may interact with the dialog system 110 by providing a user input using a client device 100. The user input may be in the form of a typed text, a gesture, a speech (audio), and so forth.

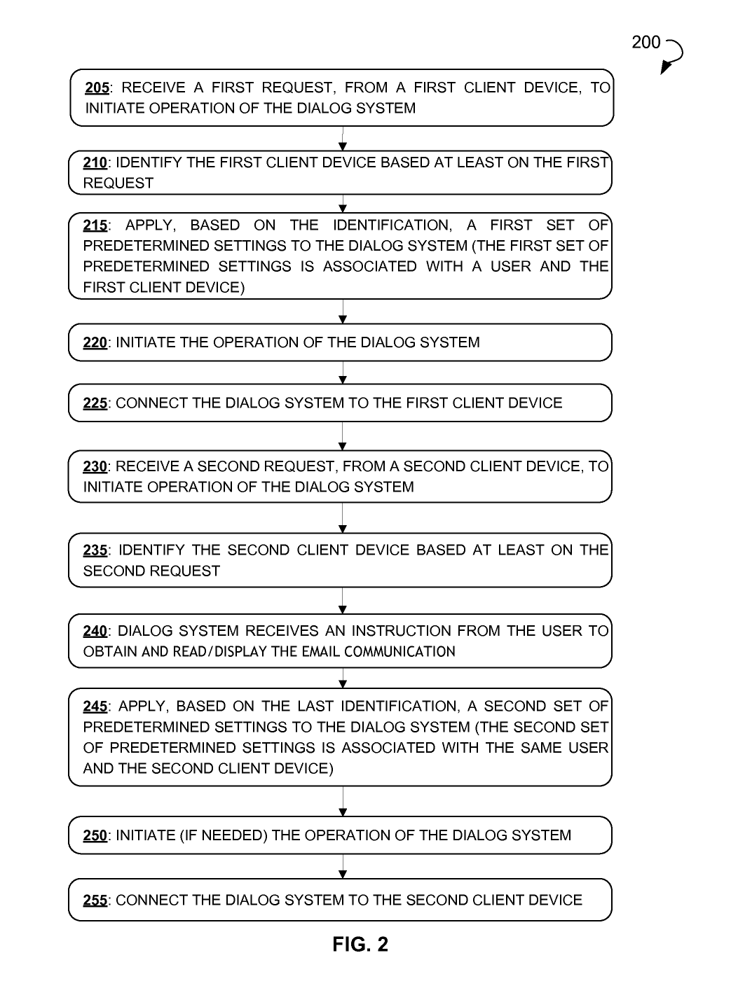

FIG. 2 is a process flow diagram showing a method 200 for operating the dialog system 110, according to an example embodiment. The method 200 may be performed by processing logic that may comprise hardware (e.g., decision-making logic, dedicated logic, programmable logic, and microcode), software (such as software run on a general-purpose computer system or a dedicated machine), or a combination of both. In one example embodiment, the processing logic refers to one or more components of the dialog system 110, manager 130, and/or dialog system backend server 120. Notably, the below recited steps of method 200 may be implemented in an order different than described and shown in FIG. 2. Moreover, the method 200 may have additional steps not shown herein, but which can be evident for those skilled in the art from the present disclosure. The method 200 may also have fewer steps than outlined below and shown in FIG. 2.

At step 205, the manager 130 receives a first request, from a first client device 100 (e.g., smart phone), to initiate operation of or to access the dialog system 110. The request may include information of a type or make of the client device, as well as user credentials and other suitable information, such as device specific information, new global preferences, device state, and so forth.

At step 210, the manager 130 identifies the first client device (i.e., it identifies its type or make or other suitable parameters). The identification is optionally based on the analysis of the first request.

At step 215, the manager 130 retrieves a first set of settings and/or rules being specific to the user of the client device 100 and associated with the first client device 100 identified. The manager 130 then applies the first set of settings and/or rules to the dialog system 110.

At step 220, the dialog system 110 is activated or its operation is initiated involving the first set of settings and/or rules.

At step 225, the dialog system 110 is connected to the first client device 100 so that the functionality of dialog system 110 is available to the user.

At step 230, assuming the user stopped using his first client device 100 (e.g., smart phone) and started using his second client device (e.g., in-vehicle computing system), the manager 130 receives a second request, from the second client device 100, to initiate or re-initiate (if applicable) the operation of dialog system 110. The second request may also include information of a type or make of the second client device 100, as well as user credentials and other suitable information.

At step 235, similar to above, the manager 130 identifies the second client device (i.e., it identifies its type or make or other suitable parameters). The identification is optionally based on the analysis of the second request.

At step 240, the manager 130 retrieves a second set of settings and/or rules being specific to the same user and associated with the second client device 100 identified. The manager 130 then applies the second set of settings and/or rules to the dialog system 110 at step 245.

At step 250, similar to above, the dialog system 110 is activated, or re-activated, if applicable, using the second set of settings and/or rules. At step 255, the dialog system 110 is connected to the second client device 100 so that the functionality of dialog system 110 is available to the user.

Notably, in certain embodiments, the dialog system 110 can be connected to the first client device 100 and the second client device 100 simultaneously.

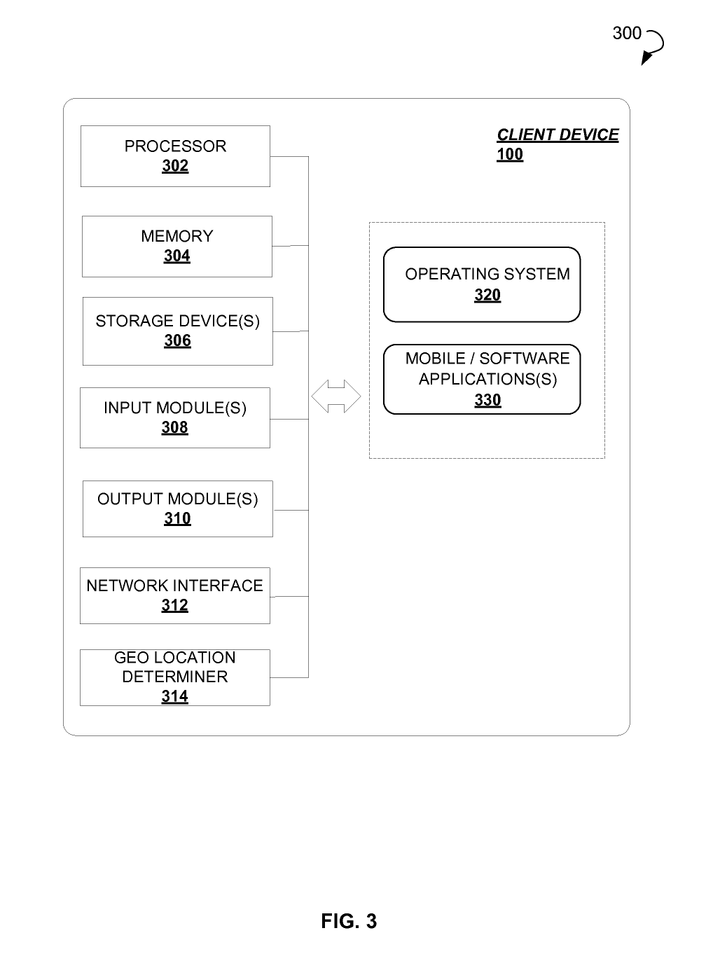

FIG. 3 is a high-level block diagram 300 illustrating an example client device 100 suitable for implementing the methods described herein. It is worth mentioning that all components of the client device 100 may include logic elements, hardware components, software (firmware) components, virtual components, or a combination thereof. The client device 100 may include, be, or be an integral part of one or more of a variety of types of devices and systems such as a general-purpose computer, desktop computer, server, computer network, network service, cloud computing service, and so forth. Further, all modules shown in FIG. 3 may be operatively coupled using any suitable wired, wireless, radio, electrical, or optical standards. As already outlined above, the client device 100 may refer to a smart phone, wireless telephone, and computer, such as a tablet computer, desktop computer, infotainment system, in-vehicle computing device, and the like.

As shown in FIG. 3, the client device 100 includes the following hardware components: one or more processors 302, memory 304, one or more storage devices 306, one or more input modules 308, one or more output modules 310, network interface 312, and optional geo location determiner 314. The client device 100 also includes the following software or virtual components: an operating system 320, dialog system 110, rules database 330, and user profile/settings database 340. The dialog system 110 provides a human-centric interface for accessing and managing information as discussed herein.

The processor(s) 302 is (are), in some embodiments, configured to implement functionality and/or process instructions for execution within the client device 100. For example, the processor(s) 302 may process instructions stored in memory 304 and/or instructions stored on storage devices 306. Such instructions may include components of an operating system 320 and dialog system 110. The client device 100 may also include one or more additional components not shown in FIG. 3, such as a housing, power supply, communication bus, and so forth. These elements are omitted so as to not burden the description of the present embodiments.

Memory 304, according to one example embodiment, is configured to store information within the client device 100 during operation. Memory 304, in some example embodiments, may refer to a non-transitory computer-readable storage medium or a computer-readable storage device. In some examples, memory 304 is a temporary memory, meaning that a primary purpose of memory 304 may not be long-term storage. Memory 304 may also refer to a volatile memory, meaning that memory 304 does not maintain stored contents when memory 304 is not receiving power. Examples of volatile memories include random access memories (RAM), dynamic random access memories (DRAM), static random access memories (SRAM), and other forms of volatile memories known in the art. In some examples, memory 304 is used to store program instructions for execution by the processors 302. Memory 304, in one example embodiment, is used by software (e.g., the operating system 320) or dialog system 110 executing on client device 100 to temporarily store information during program execution. One or more storage devices 306 can also include one or more transitory or non-transitory computer-readable storage media and/or computer-readable storage devices. In some embodiments, storage devices 306 may be configured to store greater amounts of information than memory 304. Storage devices 306 may further be configured for long-term storage of information. In some examples, the storage devices 306 include non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

Still referencing FIG. 3, the client device 100 includes one or more input modules 308. The input modules 308 are configured to receive user inputs. Examples of input modules 308 include a microphone, keyboard, keypad, mouse, trackball, touchscreen, touchpad, or any other device capable of detecting an input from a user or other source in the form of speech, audio, or tactile actions, and relaying the input to the client device 100 or components thereof. The output modules 310, in some example embodiments, are configured to provide output to users through visual or auditory channels. Output modules 310 may include a video graphics adapter card, liquid crystal display (LCD) monitor, light emitting diode (LED) monitor, sound card, speaker, or any other device capable of generating output that may be intelligible to a user.

The client device 100, in certain example embodiments, includes network interface 312. The network interface 312 can be utilized to communicate with external devices, servers, networked systems via one or more communications networks such as one or more wired, wireless, or optical networks including, for example, the Internet, intranet, local area network (LAN), wide area network (WAN), cellular phone networks (e.g., Global System for Mobile (GSM) communications network, packet switching communications network, circuit switching communications network), Bluetooth radio, and an IEEE 802.11-based radio frequency network, among others. The network interface 312 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as Universal Serial Bus (USB).

The client device 100 may further include a geo location determiner 314 for determining a current geographical location of the client device. The geo location determiner 314 may utilize a number of different methods for determining geographical location including, for example, receiving and processing signals of GPS, GLONASS satellite navigation systems, or Galileo satellite navigation system; utilizing multilateration of radio signals between radio towers (base stations); or utilizing geolocation methods associated with Internet Protocol (IP) addresses, Media Access Control (MAC) addresses, Radio-Frequency Identification (RFID), or other technologies.

The operating system 320 may control one or more functionalities of client device 100 or components thereof. For example, the operating system 320 may interact with mobile or software applications 330 and may further facilitate one or more interactions between elements 120-140 and one or more of processors 302, memory 304, storage devices 306, input modules 308, and output modules 310. As shown in FIG. 3, the operating system 320 may interact with or be otherwise coupled to the dialog system 110 and components thereof. In some embodiments, the dialog system 110 can be included into the operating system 320. Notably, the client device 100 and its components, such as the dialog system 110, may also interact with one or more remote storage or computing resources including, for example, web resources, websites, social networking websites, blogging websites, news feeds, email servers, web calendars, event databases, ticket aggregators, map databases, points of interest databases, and so forth.

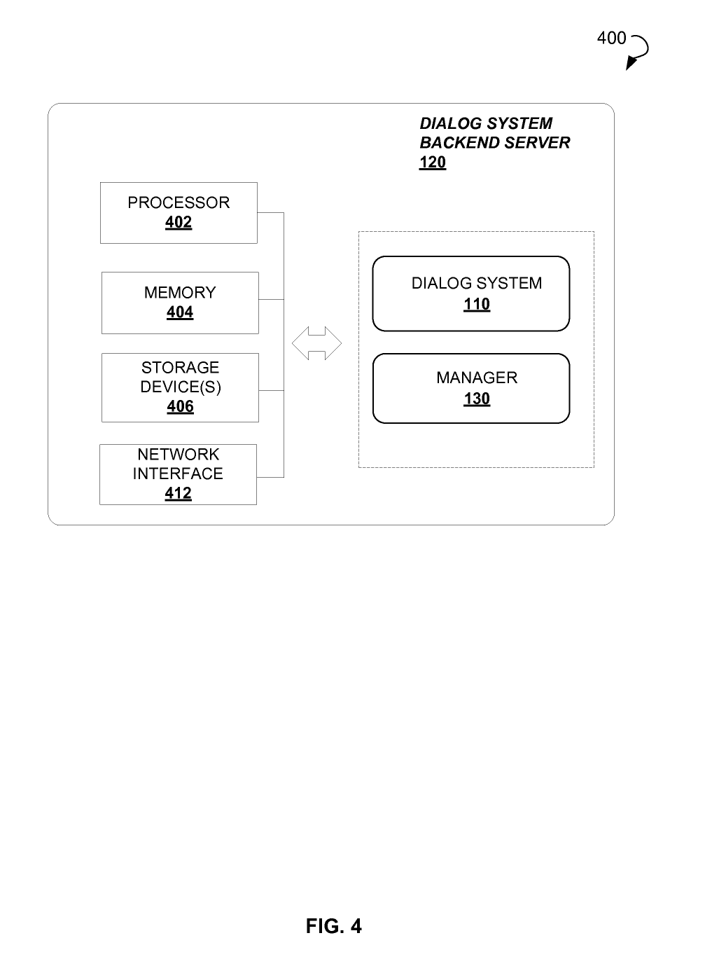

FIG. 4 is a high-level block diagram 400 illustrating the dialog system backend server 120 suitable for implementing the methods described herein. Notably, all components of the dialog system backend server 120 may include logic elements, hardware components, software (firmware) components, virtual components, or a combination thereof. The dialog system backend server 120 may include, be, or be an integral part of one or more of a variety of types of devices and systems such as a general-purpose computer, desktop computer, server, computer network, network service, cloud computing service, among others. Further, all modules shown in FIG. 4 may be operatively coupled using any suitable wired, wireless, radio, electrical, or optical standards.

As shown in FIG. 4, the dialog system backend server 120 includes the following hardware components: one or more processors 402, memory 404, one or more storage devices 406, and network interface 412. The dialog system backend server 120 also includes the dialog system 110 and the manager 130, which may be implemented as software or virtual elements. The dialog system 110 provides a human-centric interface for accessing and managing information as discussed herein.

The processor(s) 402 is(are), in some embodiments, configured to implement functionality and/or process instructions for execution within the dialog system backend server 120. For example, the processor(s) 402 may process instructions stored in memory 304 and/or instructions stored on storage devices 306. Such instructions may include components of dialog system 110. The dialog system backend server 120 may also include one or more additional components not shown in FIG. 3, such as a housing, power supply, communication bus, and so forth. These elements are omitted so as to not burden the description of the present embodiments.

Memory 404, according to one example embodiment, is configured to store information within the dialog system backend server 120 during operation. Memory 404, in some example embodiments, may refer to a non-transitory computer-readable storage medium or a computer-readable storage device. In some examples, memory 404 is a temporary memory, meaning that a primary purpose of memory 404 may not be long-term storage. Memory 404 may also refer to a volatile memory, meaning that memory 404 does not maintain stored contents when memory 404 is not receiving power. Examples of volatile memories include RAM, DRAM, SRAM, and other forms of volatile memories known in the art. In some examples, memory 404 is used to store program instructions for execution by the processors 402. Memory 404, in one example embodiment, is used by software or dialog system 110, executing on dialog system backend server 120, to temporarily store information during program execution. One or more storage devices 406 can also include one or more transitory or non-transitory computer-readable storage media and/or computer-readable storage devices. In some embodiments, storage devices 406 may be configured to store greater amounts of information than memory 404. Storage devices 406 may further be configured for long-term storage of information. In some examples, the storage devices 406 include non-volatile storage elements. Examples of such non-volatile storage elements include magnetic hard discs, optical discs, solid-state discs, flash memories, forms of EPROM or electrically erasable and programmable memories, and other forms of non-volatile memories known in the art.

The dialog system backend server 120 also includes network interface 412. The network interface 412 can be utilized to communicate with external devices, servers, and networked systems via one or more communications networks such as one or more wired, wireless, or optical networks including, for example, the Internet, intranet, LAN, WAN, cellular phone networks, packet switching communications network, circuit switching communications network, Bluetooth radio, and an IEEE 802.11-based radio frequency network, among others.

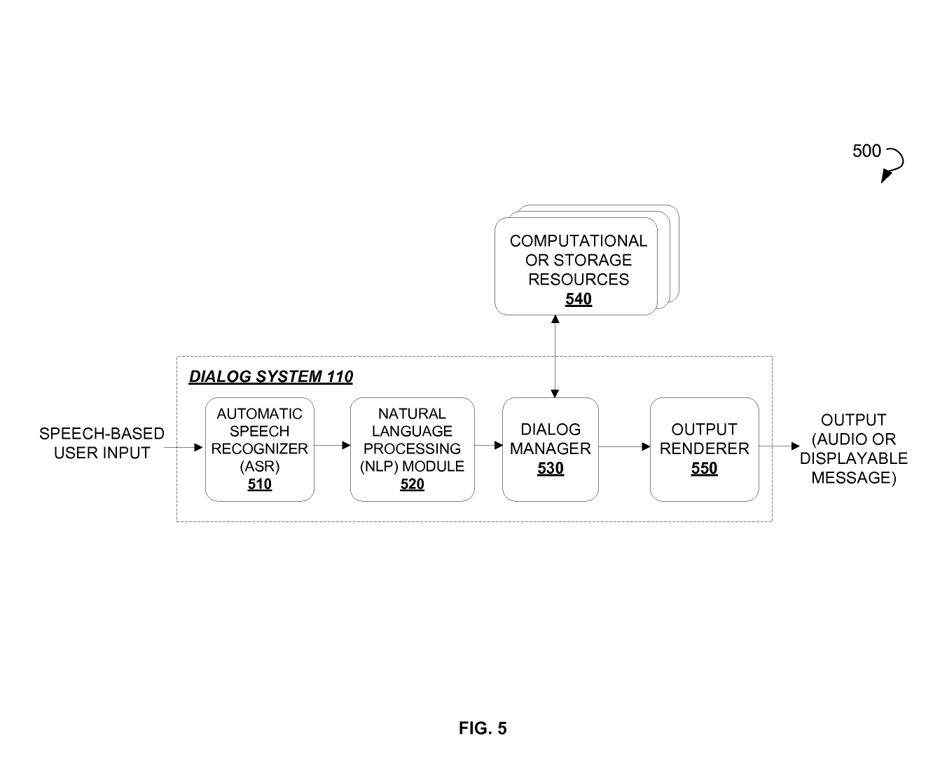

FIG. 5 shows a high-level architecture 500 of exemplary spoken dialog system 110, according to an example embodiment. It should be noted that every module of the dialog system 110 or associated architecture includes hardware components, software components, or a combination thereof. The dialog system 110 may be embedded or installed in the client device or server, or may be presented as a cloud computing module and/or a distributed computing module.

In the shown embodiment, the dialog system 110 includes an automatic speech recognizer (ASR) 510 configured to receive and process speech-based user inputs into a sequence of parameter vectors. The ASR 510 further converts the sequence of parameter vectors into a recognized input (i.e., a textual input having one or more words, phrases, or sentences). The ASR 510 includes one or more speech recognizers such as a pattern-based speech recognizer, free-dictation recognizer, address book based recognizer, dynamically created recognizer, and so forth.

Further, the dialog system 110 includes a natural language processing (NLP) module 520 for understanding spoken language input. Specifically, the NLP module 520 may disassemble and parse the recognized input to produce utterances, which are then analyzed utilizing, for example, morphological analysis, part-of-speech tagging, shallow parsing, and the like, and then map recognized input or its parts to meaning representations.

The dialog system 110 further includes a dialog manager 530, which coordinates the activity of all components, controls dialog flows, and communicates with external applications, devices, services, or resources. The dialog manager 530 may play many roles, which include discourse analysis, knowledge database query, and system action prediction based on the discourse context. In some embodiments, the dialog manager 530 may contact one or more task managers (not shown) that may have knowledge of specific task domains. In some embodiments, the dialog manager 530 may communicate with various computational or storage resources 540, which may include, for example, a content storage, rules database, recommendation database, push notification database, electronic address book, email or text agents, dialog history database, disparate knowledge databases, map database, points of interest database, geographical location determiner, clock, wireless network detector, search engines, social networking websites, blogging websites, news feeds services, and many more. The dialog manager 530 may employ multiple disparate approaches to generate outputs in response to recognized inputs. Some approaches include the use of statistical analysis, machine-learning algorithms (e.g., neural networks), heuristic analysis, and so forth. The dialog manager 530 is one of the central components of dialog system 110. The major role of the dialog manager 530 is to select the correct system actions based on observed evidences and inferred dialog states from the results of NLP (e.g., dialog act, user goal, and discourse history). In addition, the dialog manager 530 should be able to handle errors when the user input has ASR and NLP errors caused by noises or unexpected inputs.

The dialog system 110 may further include an output renderer 550 for transforming the output of the dialog manager 530 into a form suitable for providing to the user. For example, the output renderer 550 may employ a text-to-speech engine or may contact a pre-recorded audio database to generate an audio message corresponding to the output of the dialog manager 530. In certain embodiments, the output renderer 550 may present the output of the dialog manager 530 as a text message, an image, or a video message for further displaying on a display screen of the client device.

Thus, the dialog system and method of its operation have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for operating a dialog system in a cross-platform environment, the method comprising:
receiving, by a server comprising at least one processor and a memory storing processor-executable codes, a first request, from a first client device, to initiate operation of the dialog system;
identifying, by the server, the first client device based at least on the first request;
based on the identification, applying, by the server, a first set of predetermined settings to the dialog system, wherein the first set of predetermined settings is associated with a user and the first client device;
initiating, by the server, the operation of the dialog system; and
connecting, by the sever, the dialog system to the first client device.

2. The method of claim 1, wherein the first request includes one or more of the following: a type of the first client device, a make of the first client device, user credentials, device specific information, global preferences, and a state of the first client device.

3. The method of claim 1, further comprising, based on the identification, retrieving from a database, by the server, a first set of predetermined settings to the dialog system.

4. The method of claim 1, further comprising:
receiving, by the server, a second request, from a second client device, to initiate operation of the dialog system;
identifying, by the server, the second client device based at least on the second request;
based on the identification, applying, by the server, a second set of predetermined settings to the dialog system, wherein the second set of predetermined settings is associated with the same user and the second client device;
initiating, by the server, the operation of the dialog system; and
connecting, by the sever, the dialog system to the second client device.

5. The method of claim 4, wherein both the first set of predetermined settings and the second set of predetermined settings include dialog system operational rules created by the user, wherein each of the dialog system operational rules is associated with a specific user command.

6. The method of claim 4, wherein the first set of predetermined settings is configured to enable communication of hardware or software elements of the first client device with the dialog system.

7. The method of claim 4, wherein the second set of predetermined settings is configured to enable communication of hardware or software elements of the second client device with the dialog system.

8. The method of claim 4, wherein the first set of predetermined settings and the second set of predetermined settings include uniform settings associated with an avatar or uniform settings associated with audio delivery of dialog system messages.

9. A system for operating a dialog system in a cross-platform environment, the method comprising:
a dialog system deployed on a server and configured to generate and communicate a response upon receipt of a request of a user; and
a dialog system manager deployed on the server and configured to:
receive a first request, from a first client device, to initiate operation of the dialog system;
identify the first client device based at least on the first request;
based on the identification, apply a first set of predetermined settings to the dialog system, the first set of predetermined settings associated with the user and the first client device;
initiate the operation of the dialog system; and
connect the dialog system to the first client device.

10. The system of claim 9, wherein the first request includes one or more of the following: a type of the first client device, a make of the first client device, user credentials, device specific information, global preferences, and a state of the first client device.

11. The system of claim 9, wherein the dialog system manager is further configured to retrieve, from a database, a first set of predetermined settings to the dialog system based on the identification.

12. The system of claim 9, wherein the dialog system manager is further configured to:
receive a second request, from a second client device, to initiate operation of the dialog system;
identify the second client device based at least on the second request;
based on the identification, apply a second set of predetermined settings to the dialog system, wherein the second set of predetermined settings is associated with the same user and the second client device;
initiate the operation of the dialog system; and
connect the dialog system to the second client device.

13. The system of claim 12, wherein both the first set of predetermined settings and the second set of predetermined settings include dialog system operational rules created by the user, wherein each of the dialog system operational rules is associated with a specific user command.

14. The system of claim 12, wherein the first set of predetermined settings is configured to enable communication of hardware or software elements of the first client device with the dialog system.

15. The system of claim 12, wherein the second set of predetermined settings is configured to enable communication of hardware or software elements of the second client device with the dialog system.

16. The system of claim 12, wherein the first set of predetermined settings and the second set of predetermined settings include uniform settings associated with an avatar or uniform settings associated with audio delivery of dialog system messages.

17. The system of claim 9, wherein the dialog system is further configured to:
receive and process, by an automatic speech recognizer, speech-based user inputs into a sequence of parameter vectors; and
convert the sequence of the parameter vectors into a recognized input.

18. The system of claim 17, wherein the dialog system is further configured to:
disassemble and parse, by a natural language processing module, the recognized input to produce at least one utterance;
analyzed the at least one utterance utilizing one or more of the following: morphological analysis, part-of-speech tagging, and shallow parsing;
map the recognized input or one or more parts of the recognized input to meaning representations.

19. The system of claim 18, wherein the dialog system is further configured to:
generate output in response to the recognized input using one or more of the following: a statistical analysis, machine-learning algorithms, and a heuristic analysis.

20. A non-transitory processor-readable medium having instructions stored thereon, which when executed by one or more processors, cause the one or more processors to implement a method for operating a dialog system in a cross-platform environment, the method comprising:
receiving a request, from a client device, to initiate operation of the dialog system, wherein the request includes one or more of the following: a type of the client device and a make of the client device;
identifying the client device based at least on the request;
based on the identification, applying a set of predetermined settings to the dialog system, wherein the set of predetermined settings is associated with a user and the client device;
initiating the operation of the dialog system; and
connecting the dialog system to the client device.
